(19) United States
(12) Patent Application Publication
(10) Pub. No.: US 2006/0130531 A1
(43) Pub. Date: Jun. 22, 2006

(54) Deposition burner for optical fiber preform

(75) Inventors: Gu-Young Kang, Gumi-si (KR); Myung-Sop Lee, Gumi-si (KR); Jin-Han Kim, Gumi-si (KR); Yeong-Seop Lee, Gumi-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/224,217

(22) Filed: Sep. 12, 2005

(30) Foreign Application Priority Data
Dec. 16, 2004 (KR) 2004-107073

(51) Int. Cl. C03B 37/018; F23D 11/10

(52) U.S. Cl. 65/531; 65/530; 239/423; 239/548

(57) ABSTRACT

A deposition burner for an optical fiber preform includes: a first body including a plurality of injection tubes for fusing and emitting raw materials; a second body assembled with the first body in a shape to envelope the outer surface of the first body; a moving member disposed in a vertical orientation between the inner surface of the second body and the outer surface of the first body for moving in a longitudinal direction; and a switch type injection tube opened and closed along the rim of the one end of the first body in response to a movement of the moving member in the longitudinal direction.

### CLAIM OF PRIORITY

This application claims priority under 35 U.S.C. § 119 to an application entitled “Deposition Burner for Optical Fiber Preform,” filed in the Korean Intellectual Property Office on Dec. 16, 2004 and assigned Serial No. 2004-107073, the contents of which are incorporated herein by reference.

### BACKGROUND OF THE INVENTION

1. Field of the Invention

The present invention relates generally to optical fiber and in particular, to a silica glass, i.e., optical fiber preform, and an apparatus for manufacturing the same.

2. Description of the Related Art

A common method of manufacturing an optical fiber preform typically includes a vapor-phase deposition method and a sol-gel process. The sol-gel process involves manufacturing silica glass by pouring liquid raw materials into a mold, processing the liquid raw materials into a gel state, and sintering the gel materials. The sintering method is economical, and the composition of a target product can be easily controlled since it is generally performed at a low temperature.

The vapor-phase deposition method includes a modified chemical vapor deposition (MCVD) method, a vapor phase axial deposition (VAD) method, an outside vapor deposition (OVD) method, etc. The vapor-phase deposition has an advantage in that a high quality optical fiber preform can be obtained but its productivity is low and expensive manufacturing equipments must be used as a solid optical fiber preform is manufactured using a vapor phase reaction at a high temperature, reaching up to around 1800° C., for a long time.

As shown in FIGS. 1 and 2, a deposition burner 10 for the optical fiber preform fuses chemical compounds for forming SiO₂ by a plurality of injection tubes 11 deployed according to a predetermined pattern. The chemical compounds for forming SiO₂ include SiCl₄ and OMCTS. SiO₂ is formed by fusing the chemical compounds in the burner 10 using oxygen and nitrogen gas.

FIGS. 3 and 4 are schematic diagrams of a deposition equipment for an optical fiber preform 1 using the burner 10. The chemical compounds fused and emitted through the burner 10 are deposited while flowing around the optical fiber preform 1, and undeposited SiO₂ and by-products after fusing are discharged to the outside through a discharge unit 19.

For conventional deposition burners as described above, if they are in a produced state, it is impossible to change a deposition condition during an optical fiber preform deposition process except independently controlling the amount of supplied gas and the mass flux of oxygen and nitrogen gas used for fusing. In the OVD method, a diameter of the optical fiber preform increases in response to a deposition progress of the optical fiber preform, thereby resulting in a problem in that the deposition cannot be uniformly achieved. This problem is mainly caused by steadily maintaining flames emitted by the conventional deposition burners regardless of the change in the deposition condition accompanied by a gradual increase of the diameter of the optical fiber preform.

Referring to FIGS. 3 and 4, flame 13 emitted from the burner 10 covers and flows around the optical fiber preform 1, showing a separation phenomenon of unable to maintain a constant flow around the optical fiber preform 1 after going a certain distance away from the burner 10. Due to this separation phenomenon, when the diameter of the optical fiber preform 1 gradually increases, separation points 17 are grow apart from each other, thereby gradually expanding a region in which the flow of the flame 13 is not uniform.

As a result, the separation phenomenon is an obstacle preventing an optical fiber preform from being uniformly deposited along the optical fiber preform.

### SUMMARY OF THE INVENTION

The present invention provides a deposition burner for an optical fiber preform that enables an uniform deposition of the optical fiber preform by changing an injection condition in response to a gradual increase in the diameter of the optical fiber preform.

In one embodiment, there is provided a deposition burner for an optical fiber preform which includes: a first body including a plurality of injection tubes for fusing and emitting raw materials that are formed at one end thereof; a second body assembled with the first body in a shape of enveloping the outer surface of the first body; a moving member moving in a longitudinal direction and located between the inner surface of the second body and the outer surface of the first body; and a switch type injection tube opened and closed along the rim of one end of the first body in response to a movement of the moving member on the first body in the longitudinal direction.

### BRIEF DESCRIPTION OF THE DRAWINGS

The above features and advantages of the present invention will become more apparent from the following detailed description when taken in conjunction with the accompanying drawings in which:

FIG. 1 is a cross sectional diagram of a deposition burner for an optical fiber preform according to a prior art;

FIG. 2 is a plan view of the burner shown in FIG. 1;

FIGS. 3 and 4 are schematic diagrams of a deposition equipment for an optical fiber preform using the burner shown in FIG. 1;

FIG. 5 is a cross sectional diagram of a deposition burner for an optical fiber preform according to an embodiment of the present invention;

FIG. 6 is a plan view of the burner shown in FIG. 5;

FIG. 7 is a cross sectional diagram of the burner shown in FIG. 5 after a moving member of the burner has moved; and

FIGS. 8 and 9 are schematic diagrams of a deposition equipment for an optical fiber preform using the burner shown in FIG. 5.

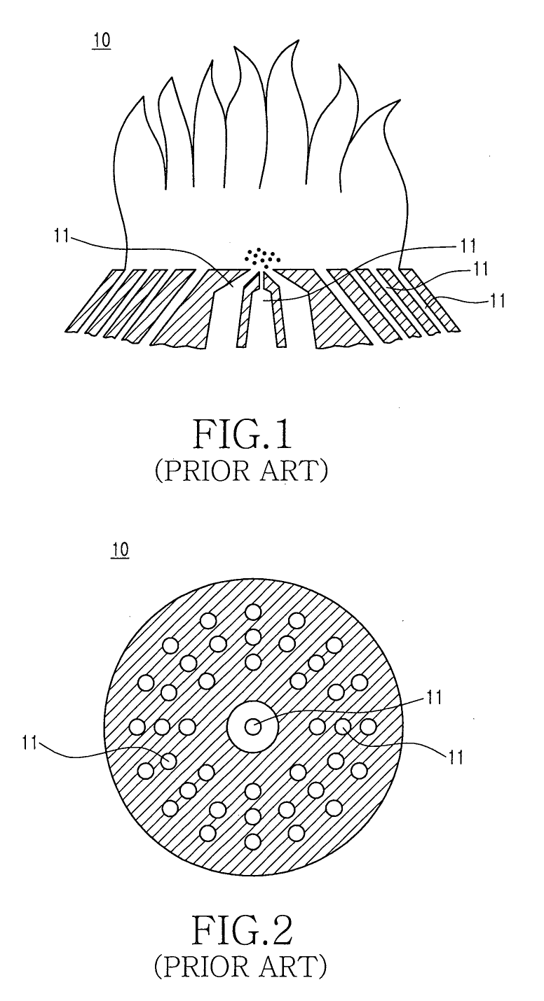

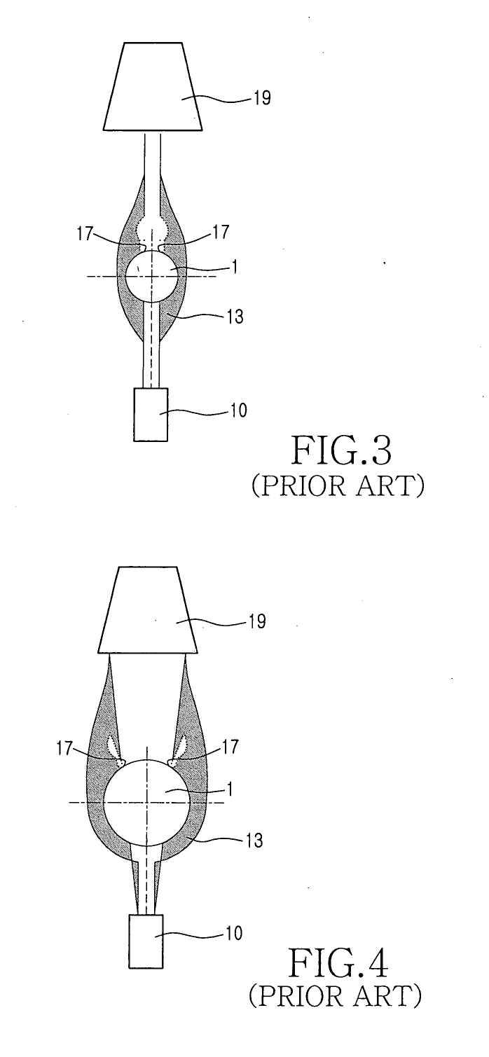

### DETAILED DESCRIPTION

Now, embodiments of the present invention will be described herein below with reference to the accompanying drawings. In the drawings, the same or similar elements are denoted by the same reference numerals even though they are depicted in different drawings. For the purposes of clarity and simplicity, well-known functions or constructions are not described in detail as they would obscure the invention in unnecessary detail.

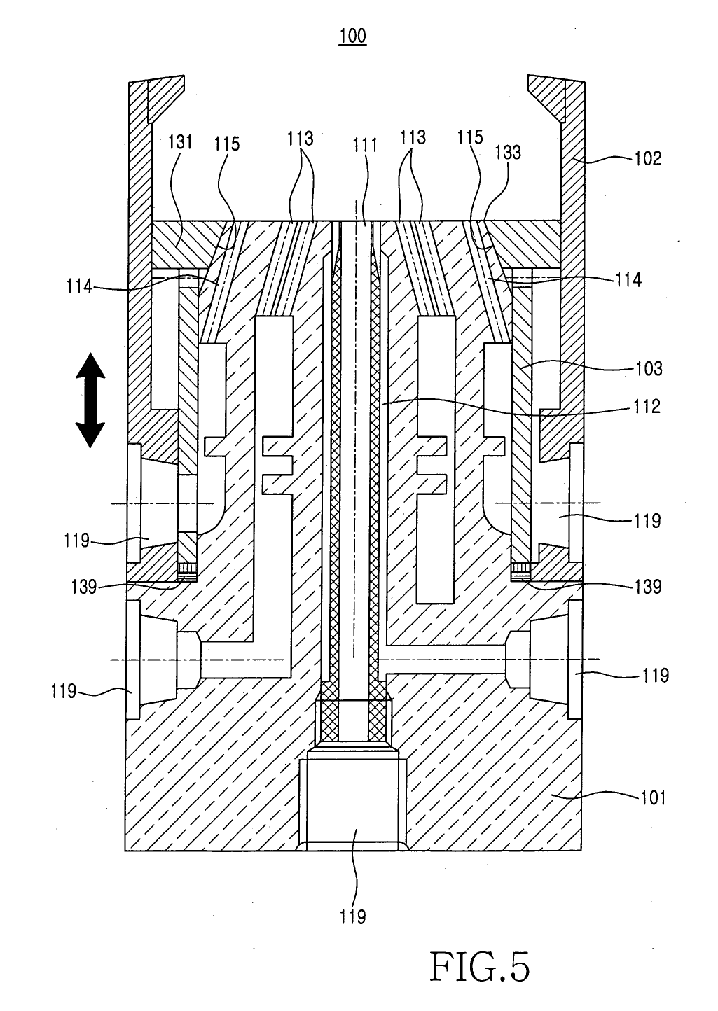

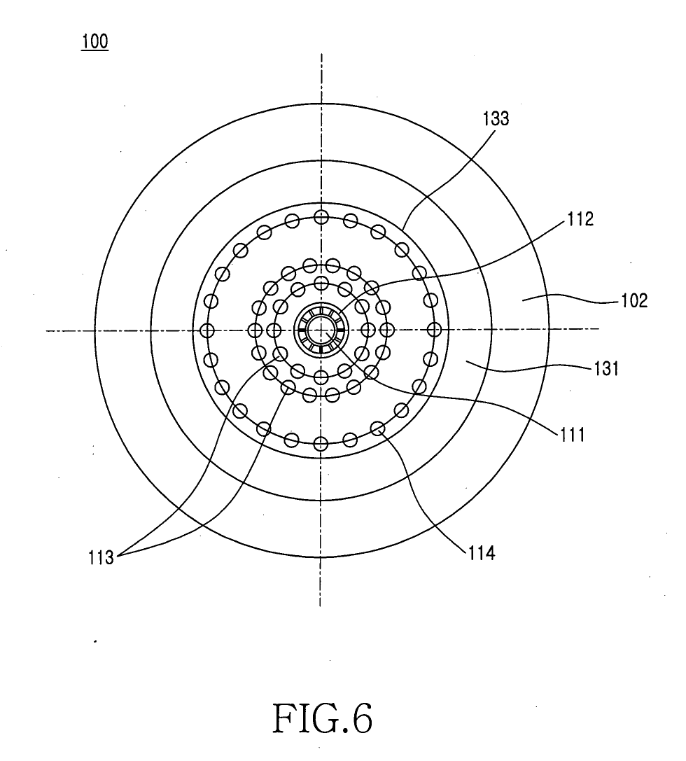

Referring to FIGS. 5 to 7, the burner 100 includes a first body 101, a second body 102, and the moving member 103.

The first body 101 includes a plurality of injection tubes 111, 112, 113, and 114 formed at one end thereof and a plurality of inlets 119 formed on the outer surface to feed chemical compounds. The injection tubes are comprised of a first injection tube 111 formed at a center portion of the first body 101, a plurality of second injection tubes 112 deployed in an outer circumference direction from the first injection tube 111, a plurality of third injection tubes 113 deployed by at least one row in the outer circumference direction from the second injection tubes 112, and a plurality of fourth injection tubes 114 deployed in the outer circumference direction from the third injection tubes 113.

SiCl₄ and OMCTS are fed into the first injection tube 111, O₂ and N₂ are fed into the second injection tubes 112, mixed gas such as CH₄+O₂ and H₂+O₂ are fed into the third injection tubes 113, and O₂, N₂ and Ar are fed into the fourth injection tubes 114. The composition of the chemical compounds fed into the injection tubes can be selectively changed by a manufacturer according to the desired characteristic of optical fiber to be manufactured.

The second body 102 is assembled with the first body 101 to envelop the outer surface of the first body 101 and guides the flame emitted from the burner 100 to maintain a constant shape by being further extended by a predetermined length from the one end of the first body 101.

The moving member 103 is assembled between the outer surface of the first body 101 and the inner surface of the second body 102, which are apart from each other by a predetermined distance.

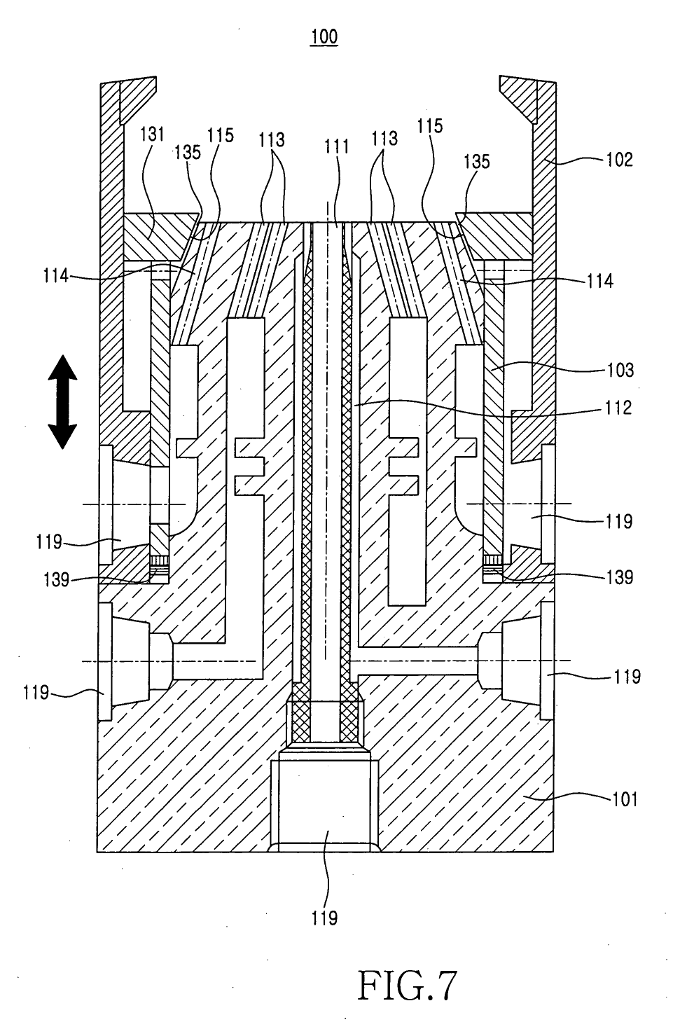

The moving member 103 is assembled to move in a longitudinal direction of the first body 101 and a ring-shaped cover plate 131 formed at one end thereof. The cover plate 131 serves to close a space between the outer surface of the first body 101 and the inner surface of the second body 102, forming a switch type injection tube 135 (shown in FIG. 7) along the outer surface of the first body 101 in response to a movement of the moving member 103.

That is, according to the movement of the moving member 103, the space between the outer surface of the first body 101 at one end and the inner surface of the cover plate 131 is opened, thereby forming another type of an injection tube. For the formation of the switch type injection tube 135, a slope 115 is formed on the outer surface of the first body 101 at one end, and the inner surface of the cover plate 131 is formed to correspond to the slope 115. The slope 115 is formed so that its diameter gradually decreases towards the one end of the first body 101.

The switch type injection tube 135 is closed in a state in which the outer surface of the first body 101 meets the inner surface of the moving member 103, and is opened in a state in which the outer surface of the first body 101 is apart from the inner surface of the moving member 103 due to the movement of the moving member 103. It is preferable that gas emitted from the switch type injection tube 135 is O₂, N₂ and Ar, and an inlet 119 to feed the gas can be formed on the outer surface of the second body 102.

In the state in which the switch type injection tube 135 is closed, the surface of one end of the cover plate 131 contacts the surface of the one end of the first body 101.

In order for the flame emitted from the burner 100 to form the constant shape, it is preferable that a discontinuous shape is minimized on the surface of one end of the burner 100. To achieve this, it is preferable that a boundary line 133 is formed by matching the rim of the first body 101 at one end to the surface end of the cover plate 131.

To actuate the moving member 103, a driving member 139 is assembled with the burner 100. One end of the driving member 139 is supported by the outer surface of the first body 101, and the other end is supported by the other end of the moving member 103. It is preferable that the driving member 139 is made of a metal capable of varying its shape in response to a change in temperature, e.g., a bimetal. The bimetal is constituted by uniting two metals having different rates of thermal expansion, thereby varying its shape according to the difference in the thermal expansion rate caused by temperature change.

In additional to the bimetal, the driving member 139 can be constituted using a metal having a rate of thermal expansion so that the switch type injection tube 135 can be opened and closed as the moving member 103 moves. As a metal satisfying this condition, there exist an aluminum alloy, a copper alloy, and a zinc alloy.

It can be understood that a hastelloy series alloy or a quartz material having a low rate of thermal expansion may be used for components, except the driving member 139, such as the first body 101, the second body 102, and the moving member 103.

In response to a change in the shape of the driving member 139 due to the surrounding temperature changes while the optical fiber preform is being deposited, the moving member 103 moves to enable the switch type injection tube 135 to open.

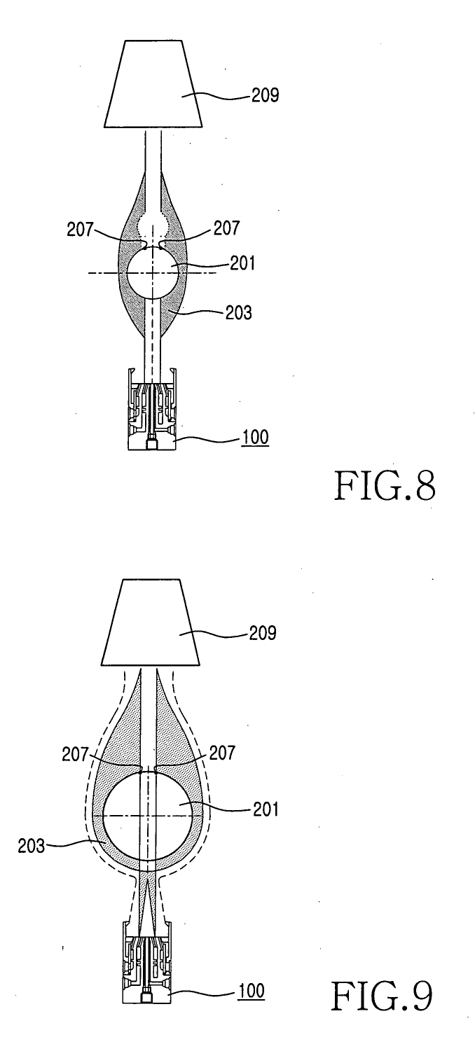

FIG. 8 is a schematic diagram of a deposition device to manufacture an optical fiber preform 201 using the burner 100 described above. In particular, FIG. 8 shows an initial state of an optical fiber preform process. FIG. 9 illustrates a state in which a diameter of the optical fiber preform 201 is increased after the optical fiber preform process is performed for a predetermined time period. By-products after fusing, which are emitted from the burner 100 but not deposited on the optical fiber preform 201, are discharged to the outside through a discharge unit 209.

In operation, as the deposition process continues, the diameter of the optical fiber preform 201 is gradually increased, thereby making a distance between the outer surface of the optical fiber preform 201 and the burner 100 closer while increasing the surface area of the optical fiber preform 201 facing the burner 100. As a result, radiant heat of the optical fiber preform 201 transferred to the burner 100 gradually increases as the deposition process continues.

An increase in the radiant heat transferred to the burner 100 causes the surrounding temperature of the moving member 139 to be increased as well. This causes the transformation of the moving member 139 to gradually move downward, thus enabling the switch type injection tube 135 gradually open. As more deposition of the optical fiber preform 201 continues, the radiant heat transferred to the burner 100 increases, thereby increasing the size of the switch type injection tube 135.

The gas emitted from the switch type injection tube 135 flows around flame 203 emitted from the burner 100, thereby maintaining the shape of the flame 203 constantly and preventing separation points 207 of the flame 203 from being farther apart from each other as in the prior art. Thus, a region in which the flame 203 discontinuously flows between the separation points 207 is restrained from being extended, thereby maintaining the deposition of the optical fiber preform 201 uniformly.

As described above, a deposition burner according to the present invention can uniformly maintain the flow of flame flowing around the optical fiber preform even when diameter of the optical fiber preform increases, by opening a switch type injection tube that is activated due to the surrounding temperature of the burner that increases in response to a radiation heat transferred from the optical fiber preform to the burner. Thus, quality of the optical fiber preform is improved by uniformly maintaining the deposition of the optical fiber preform by changing an injection condition to be suited to a change of a deposition condition of the optical fiber preform. In addition, while equipments for a separate control such as a mass flux control are required to respond to the change in the deposition condition in a prior art, the deposition burner according to the present invention changes the injection condition using the switch type injection tube, thereby simplifying a deposition equipment.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A deposition burner for an optical fiber preform, comprising:
a first body including a plurality of injection tubes for fusing and emitting raw materials;
a second body coupled the first body and having a shape for enveloping the outer surface of the first body;
a moving member located between the second body and the first body in a vertical orientation; and
a switch type injection tube, defined by a boundary between the second body and the moving member, opened and closed along the rim of the first body in response to a movement of the moving member.

2. The burner of claim 1, wherein the surface of one end of the moving member is matched to the surface of one end of the first body when the switch type injection tube is closed.

3. The burner of claim 1, wherein a diameter of the outer circumference of the first body gradually decreases in a direction toward the one end of the first body.

4. The burner of claims 1, further comprising:
a driving member whose one end is supported by the outer surface of the first body and the other end is supported by the moving member,
wherein in response to a surrounding temperature, the moving member moves thereby opening the switch type injection tube.

5. The burner of claim 4, wherein the driving member is a bimetal.

6. The burner of claim 4, wherein the driving member is one metal selected among aluminum alloy, copper alloy, and zinc alloy.

7. The burner of claim 1, wherein the plurality of injection tubes comprises:
a first injection tube formed at the center the first body;
a plurality of second injection tubes deployed in an outer circumference direction from the first injection tube;
a plurality of third injection tubes deployed by at least one row in the outer circumference direction from the second injection tubes; and
a plurality of fourth injection tubes deployed in the outer circumference direction from the third injection tubes.

8. The burner of claim 7, wherein the switch type injection tube is formed in the circumference direction along the surrounding of the fourth injection tubes.

9. The burner of claim 1, wherein O₂, N₂ and Ar gases are supplied through the opened switch type injection tube.
